(19) United States
(12) Patent Application Publication
(10) Pub. No.: US 2006/0242019 A1
(43) Pub. Date: Oct. 26, 2006

(54) METHOD AND APPARATUS FOR OFFERING FORWARD COMMITMENT AGREEMENTS

(76) Inventors: Jay S. WALKER, Ridgefield, CT (US); James A. Jorasch, Stamford, CT (US); Russell P. Sammon, San Francisco, CA (US); Geoffrey M. Gelman, Stamford, CT (US); Magdalena M. Fincham, Norwalk, CT (US); Leonardo Ali Booth, New Haven, CT (US); Steven M. Santisi, Ridgefield, CT (US)

Correspondence Address: WALKER DIGITAL, 2 HIGH RIDGE PARK, STAMFORD, CT, 06905, US

(21) Appl. No.: 11/427,422

(22) Filed: Jun. 29, 2006

Related U.S. Application Data
(63) Continuation of application No. 10/120,529, filed on Apr. 10, 2002.
(60) Provisional application No. 60/282,828, filed on Apr. 10, 2001.

(51) Int. Cl. G06Q 30/00; G06F 7/08

(52) U.S. Cl. 705/14; 235/381

(57) ABSTRACT

The invention includes a system and method for presenting forward commitment agreements to consumers proximate to a benefit dispensing device such as a vending machine or an automatic teller machine. A controller is in communication with one or more benefit dispensing devices and one or more merchant devices. Merchants devise forward commitment agreements to be offered to consumers. Such agreements specify a benefit that will be provided to a consumer immediately if the consumer agrees to fulfill a commitment in the future. Using a merchant device, a merchant communicates descriptions of the forward commitment agreements to the controller. When a consumer subsequently accesses a benefit dispensing device, the controller, via the benefit dispensing device, offers a forward commitment agreement to the consumer. If the consumer chooses to enter into the forward commitment agreement, then the benefit dispensing device provides the consumer with an immediate benefit. In some embodiments, the merchant subsequently reimburses the controller for the benefit provided to the consumer.

### RELATED APPLICATIONS

This application is related to commonly owned, co-pending U.S. patent application Ser. No. 09/672,066, filed Sep. 28, 2000, entitled “Method For Allowing A Customer To Obtain A Discounted Price For Transaction And Terminal For Performing The Method”; commonly owned, co-pending U.S. patent application Ser. No. 09/607,884, filed Jun. 30, 2000, entitled “Methods And Apparatus For Obtaining And Employing Commitments To Patronize One Or More Restaurants”; commonly owned, co-pending U.S. patent application Ser. No. 09/685,159, filed Oct. 6, 2000, entitled “Method And Apparatus For Offering Customized Negotiable Pricing”; commonly owned, co-pending U.S. patent application Ser. No. 09/609,454, filed Jun. 30, 2000, entitled “Method And Apparatus For Presenting And Selecting Product Agreements”; commonly owned, co-pending U.S. patent application Ser. No. 09/604,898, filed Jun. 28, 2000, entitled “Method And Apparatus For Conducting Or Facilitating A Promotion”; commonly owned, co-pending U.S. patent application Ser. No. 09/609,147, filed Jun. 30, 2000, entitled “Method And Apparatus For Compensating Participation In Marketing Research”; commonly owned, co-pending U.S. patent application Ser. No. 09/709,235, filed Nov. 10, 2000, entitled “Method And Apparatus For Conducting Focus Groups Using Networked Gaming Devices”; commonly owned, co-pending U.S. patent application Ser. No. 09/540,034, filed Mar. 31, 2000, entitled “Systems And Methods Wherein A Third Party Subsidy And A Merchant Subsidy Facilitate A Transaction”; commonly owned U.S. patent Ser. No. 09/605,668 filed Jun. 28, 2000, entitled “Method And Apparatus For Establishing An Agreement For Future Performance”; commonly owned U.S. patent Ser. No. 09/526,907, filed Mar. 16, 2000, entitled “Systems And Methods For Providing A Subsidy Offer Through A Customer Device”, commonly owned, co-pending U.S. patent application Ser. No. 09/349,860, filed Jul. 8, 1999, entitled “Method And Apparatus For Identifying Potential Buyers”; commonly owned, co-pending U.S. patent application Ser. No. 09/410,267 filed Sep. 30, 1999, entitled “System And Method For Increasing The Audience For Media Programming”; commonly owned, co-pending U.S. patent application Ser. No. 09/316,546, filed May 21, 1999, entitled “Method And Apparatus For Processing Credit Card Transactions”; commonly owned, co-pending U.S. patent application Ser. No. 09/322,351, filed May 28, 1999, entitled “Method And Apparatus For Providing Cross Benefits And Penalties”; and commonly owned, co-pending U.S. patent application Ser. No. 09/223,903, filed Dec. 31, 1998, entitled “System And Method For Negative Retroactive Discounts,” all of which are incorporated herein by reference in their entirety for all purposes.

### FIELD OF THE INVENTION

The present invention relates to methods and apparatus for performing electronic commerce and automated sales. More specifically, the present invention relates to offering forward commitment agreements via networked and/or stand-alone devices.

### BACKGROUND OF THE INVENTION

Customer acquisition is integral to any business. The lifetime value of a new customer can be enormous for businesses such as credit card issuers, airlines, casinos, and life insurance companies. Thus, many businesses spend significant amounts of money on customer acquisition. Existing advertising methods are often ineffective as customer acquisition tools. Advertisements are so pervasive that they are frequently ignored. Furthermore, advertisements do not offer potential customers any special incentives for purchasing a product they do not particularly want. What is needed is an effective method of acquiring new customers. What is further needed is a system and method that allows a merchant's customer acquisition budget to be used deterministically for quantifiable acquisitions, rather than for uncertain advertising campaigns.

Due to the high demand for workers in today's economy, it is increasingly difficult to hire skilled salespeople to interact with customers. The training required to enable a sales person to sell effectively can be cost prohibitive. What is needed is a cost effective way to automate product and service sales and reduce merchants' reliance upon sales staff.

There are currently over 500,000 slot machines, over 500,000 ATM's, and over 10,000,000 vending machines in operation. However, despite the fact that these “sales” machines interact closely with customers everyday, the use of these machines has been limited to their primary function. What is needed is a means to use the vast number of networked sales machines to provide access to consumers and their voluntarily provided information to facilitate the establishment of relationships with the consumers.

People possess a number of obligations but may have flexibility as to how to fulfill their obligations. For example, people must buy food, but may be indifferent as to the particular brands of food they buy. Likewise, travelers may be required to use airlines and hotels but might be indifferent as to which airlines they actually use, or as to the particular hotel in which they stay. Despite consumers' flexibility, merchants have difficulty presenting consumers with incentives to try products when consumers are likely to do so. What is needed is a system and method to allow merchants to become aware of consumer's obligations and present alternative products to the consumers at opportune times.

### SUMMARY OF THE INVENTION

The present invention overcomes the above and other drawbacks of the prior art by offering a forward commitment agreement via a device capable of dispensing a benefit. According to some embodiments of the present invention, a benefit is provided to a consumer through a benefit dispensing device if the consumer agrees to do business with a merchant in the future. For the cost of the benefit, the merchant thereby obtains a new customer. Furthermore, by acquiring the new customer through an offer presented via a device, the merchant avoids costs associated with human salespeople but is still able to establish a relationship with the customer.

According to other embodiments of the present invention, a system comprises a controller in communication with one or more benefit dispensing devices and one or more merchant devices. Merchants create forward commitment agreements to be offered to consumers. Such agreements specify a benefit that will be provided to a consumer immediately if the consumer agrees to fulfill a commitment in the future. Using a merchant device, a merchant then communicates descriptions of the forward commitment agreements to the controller. When a consumer subsequently accesses a benefit dispensing device, the controller, via the benefit dispensing device, offers a forward commitment agreement to the consumer. If the consumer chooses to enter into the forward commitment agreement, then the benefit dispensing device provides the consumer with an immediate benefit. In some embodiments, the merchant subsequently reimburses the controller for the benefit provided to the consumer.

In some embodiments of the disclosed invention, forward commitment agreements are offered to consumers based on the consumers' existing obligations. For example, a consumer on vacation in Las Vegas may be obligated to find accommodations such as a hotel. Since many people in Las Vegas are there on vacation and do not have local vacation homes or local family members with whom to stay, an auspicious forward commitment agreement presented by a slot machine might offer $50.00 in gaming tokens if the consumer commits to switching his accommodations to the casino's hotel. Since the consumer must stay at a hotel anyway, he may be inclined to accept such a forward commitment offer.

In another example, a young parent may need to buy diapers periodically for the next three years. When the parent brings his family's laundry to the local Laundromat, a washing machine may prompt him with an offer. For example, all of the family's laundry will be done for free if the parent will agree to buy Pampers® diapers the next time he needs diapers. With so much laundry, and the necessity of buying diapers anyway, the parent is quite likely to accept. In this example, the Procter & Gamble company, the manufacturers of Pampers®, may be the merchant while the Laundromat owner may own the washing machine equipped to offer free washes in exchange for committing to a future purchase of Pampers®. According to some embodiments of the present invention, Procter & Gamble may agree to pay the laundry mat owner a fee for each forward commitment agreement that the laundry mat owner's washing machine establishes.

Some embodiments may also include verifying that a consumer fulfills a forward commitment. If the consumer does not, a consequence, as defined in the forward commitment agreement, may be imposed.

With these and other advantages and features of the invention that will become hereinafter apparent, the nature of the invention may be more clearly understood by reference to the following detailed description of the invention, the appended claims and to the several drawings included herein.

### BRIEF DESCRIPTION OF THE DRAWINGS

FIG. 1A is a block diagram illustrating an example system according to some embodiments of the present invention.

FIG. 1B is a block diagram illustrating an alternative example system according to some embodiments of the present invention.

FIG. 2 is a block diagram illustrating an example of a controller 102 as depicted in FIGS. 1A and 1B according to some embodiments of the present invention.

FIG. 3 is a block diagram illustrating an example of a dispensing device 106 as depicted in FIGS. 1A and 1B according to some embodiments of the present invention.

FIG. 4 is a block diagram illustrating an example of a merchant device 112 as depicted in FIGS. 1A and 1B according to some embodiments of the present invention.

FIG. 5 is a table illustrating an example data structure of an example forward commitment database 208 as depicted in FIG. 2 for use in some embodiments of the present invention.

FIG. 6 is a table illustrating an example data structure of an example of consumer database 210 as depicted in FIG. 2 for use in some embodiments of the present invention.

FIG. 7 is a table illustrating an example data structure of an example merchant database 212 as depicted in FIG. 2 for use in some embodiments of the present invention.

FIG. 8 is a table illustrating an example data structure of an example dispensing devices database 214 as depicted in FIG. 2 for use in some embodiments of the present invention.

FIG. 9 is a flow diagram illustrating an exemplary process for offering a forward commitment at a dispensing device according to and for use in some embodiments of the present invention.

### DETAILED DESCRIPTION OF THE INVENTION

In the following description, reference is made to the accompanying drawings that form a part hereof and in which is shown by way of illustration, specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

Applicants have recognized that a need exists for systems and methods that help merchants and other sellers facilitate automated sales, acquire new customers, and establish relationships with consumers. One benefit of embodiments of the present invention is that they allow a merchant's customer acquisition budget to be used for direct acquisitions, rather than for uncertain advertising campaigns. The present invention also reduces the dependency on labor in acquiring and selling to customers. In other words, using the present invention, merchants have an alternative to retaining and training sales staff to acquire and sell to customers.

Another benefit of embodiments of the present invention is that it allows the offer of a forward commitment and a corresponding benefit at a time when a consumer may be particularly motivated to accept the benefit and/or assume the commitment. Yet another benefit of embodiments of the present invention is that the consumer receives an immediate, tangible benefit at a time when he may most need it. Further, the systems of the present invention are often able to present forward commitment agreements that include a commitment that involves an act that the consumer was already planning to do anyway. Thus, a consumer may be inclined to enter into forward commitment agreements presented according to the present invention.

A. Definitions

Throughout the description that follows and unless otherwise defined, the following terms will refer to the meanings provided in this section. These terms are provided to clarify the language selected to describe the embodiments of the invention both in the specification and in the appended claims.

The terms “products,” “goods,” “merchandise,” and “services” shall be synonymous and refer to anything licensed, leased, sold, available for sale, available for lease, available for licensing, and/or offered or presented for sale, lease, or licensing including packages of products, subscriptions to products, contracts, information, services, and intangibles.

The term “merchant” shall refer to an entity who may offer to sell, lease, and/or license a product to a consumer for the consumer or on behalf of another. For example, merchants may include sales channels, individuals, companies, manufactures, distributors, direct sellers, re-sellers, and/or retailers. Merchants may transact out of buildings including stores, outlets, malls and warehouses, and/or they may transact via any number of additional methods including mail order catalogs, vending machines, online web sites, and/or via telephone marketing. Note that a manufacturer may choose not to sell to customers directly and in such a case, a retailer may serve as the manufacture's sales channel.

The term “merchant device” shall refer to a device that may be capable of receiving instructions from a merchant and of communicating instructions to a controller. The instructions may indicate products to sell, pricing information, benefits, and forward commitments.

The terms “benefit dispensing device” and “dispensing device” shall be synonymous and shall refer to any device capable of providing a benefit such as: dispensing money, dispensing a product of value, and/or performing a service of value. Dispensing devices may be of many different types including: gaming devices, vending machines, automatic teller machines (ATM), ticket dispensers, kiosks, pay phones, telephones, cell phones, networked computers, wireless personal digital assistants (PDAs), point of sale (POS) terminals, gas pumps, washing machines, dryers, juke boxes, skill crane games, arcade games, game consoles, and audio-video players. A dispensing device may include hardware and software to support the operations of the present invention in addition to the hardware and/or software used to perform the dispensing devices' primary function. Alternatively, a dispensing device may not include any hardware and/or software to support operations of the present invention except to merely receive and respond to a signal from a controller directing the dispensing device to dispense a benefit.

The term “gaming device” shall refer to any gaming machine, including slot machines, video poker machines, video bingo machines, video keno machines, video blackjack machines, video lottery terminals, etc. that is capable of dispensing value in the form of cash and/or gambling tokens. Gaming devices may or may not be owned by a casino and/or may or may not exist within a casino.

The term “casino” shall refer to the owner of gaming devices, owners' agents, and/or any entity who may profit from players' use of the gaming devices.

The term “controller” shall refer to a device that may be in communication with a merchant device, and/or a plurality of benefit dispensing devices, and may be capable of relaying communications to and from each.

The term “input device” shall refer to a device that is used to receive an input. An input device may communicate with or be part of another device (e.g. a point of sale terminal, a point of display terminal, a customer device, a merchant device, a benefit dispensing device, a controller, etc.). Some examples of input devices include: a bar-code scanner, a magnetic stripe reader, a computer keyboard, a point-of-sale terminal keypad, a touch-screen, a microphone, an infrared sensor, a sonic ranger, a computer port, a video camera, a digital camera, a GPS receiver, a motion sensor, a radio frequency identification (RFID) receiver, a RF receiver, a thermometer, a pressure sensing pad, and a weight scale.

The term “output device” shall refer to a device that is used to output information. An output device may communicate with or be part of another device (e.g. a point of sale terminal, a point of display terminal, a customer device, a merchant device, a benefit dispensing device, a controller, etc.). Possible output devices include: a cathode ray tube (CRT) monitor, liquid crystal display (LCD) screen, light emitting diode (LED) screen, a printer, an audio speaker, an infra-red transmitter, a radio transmitter.

The term “I/0 device” shall refer to any combination of input and/or output devices.

The term “frequent shopper card” shall refer to a device that may be capable of storing information about a consumer who is a shopper This information may include identifying information and shopping history information. The frequent shopper card may be machine readable, for example, by a POS terminal.

The term “player tracking card” shall refer to a device that may be capable of storing information about a consumer who is a casino player. This information may include identifying information, as well as financial information, such as a number of gambling credits remaining. The card may be machine readable, for example, by a gaming device.

The term “ATM card” shall refer to a device that may be capable of storing information about a consumer who is a bank customer. This information may include identifying information and bank account information. The ATM card may be machine readable, for example, by an automated teller machine.

The term “tangible value” shall refer to items that are intrinsically valuable such as cash that may provide a sensation of instant gratification. Tangible value is distinct from “abstract value” such as an electronic finds transfer to a bank account. In other words, tangible value may be directly perceived with the five basic senses as opposed to only being intellectually comprehended. Coins dropping into a slot machine tray and cash dispensed by an ATM are examples of tangible value, while credits or interest accumulating in an account are examples of abstract value.

The term “consequence” shall refer to a result that is imposed or enforced if a consumer who is a party to a forward commitment agreement does not fulfill an associated forward commitment. Consequences may include charging a penalty to a financial account, bringing legal action, making a public disclosure (or a disclosure to a credit reporting agency) regarding the consumer's failure to fulfill his commitment, or barring a consumer from future use of a benefit dispensing device.

The term “forward commitment agreement” and “commitment agreement” shall be synonymous and refer to an agreement between a merchant and usually a consumer, that includes at least one term that specifies a forward commitment and one term that specifies a benefit. Note that these terms are not limited to the legal definition of an agreement or a contract (e.g. a forward commitment agreement may or may not be or represent a legally binding contract). A forward commitment agreement may have transfer, assignment, and/or buyout provisions, for example, in the event that the entity bound by the forward commitment is unable or unwilling to fulfill it.

The term “forward commitment” shall refer to a commitment to do one or more of the following: purchase, use, lend, borrow, sell, lease, and/or license a product; perform work; provide an opinion; make a donation or contribution; and/or answer a question. A forward commitment does not include commitments to pay a financial debt. Thus, for example, making a purchase with a credit card does not result in a forward commitment. A forward commitment may exist in the abstract even when no one has yet agreed to be bound by the commitment. A consumer may enter into a forward commitment agreement and, as a result, assume, or become bound to, a forward commitment. Once the terms of a forward commitment agreement have been satisfied, a forward commitment may be considered as having been fulfilled.

Further, a forward commitment may commit a single person to perform a task, a single person to perform multiple tasks, multiple people to perform individual tasks, multiple people to perform a single cooperative task, or a subset of a group of people to perform individual or group tasks. A forward commitment may commit one or more entities to fulfilling unspecified tasks, with the particular tasks being identified only after an associated forward commitment agreement has been executed. A forward commitment may commit an entity to perform a task on a periodic basis, within a certain time period, or conditionally based on a related or unrelated, random or non-random event and/or outcome. A forward commitment may be defined and/or specified by the entity fulfilling the forward commitment, by a merchant or other party benefiting from the fulfillment of the forward commitment, and/or by a third party. A forward commitment may require the fulfillment of a plurality of milestone tasks. If an entity fails to meet a milestone, then the forward commitment may be deemed unfulfilled. Note that meeting a particular milestone may not necessarily indicate that the forward commitment has been fulfilled.

The term “obligation” shall refer to a task that must be done in order to satisfy a physical need, psychological pressure, or financial custom. Physical needs include eating, drinking, and sleeping. Psychological pressures may include social pressure, peer pressure, moral obligation, fear, etc. Financial custom may include for example, a parent's agreement to pay for his child's education or wedding. For example, as a person must eat, he may have an obligation to eat at a restaurant if he is away from his home kitchen. A person also might feel an obligation to meet someone at a restaurant if that someone has asked him to do so.

B. System

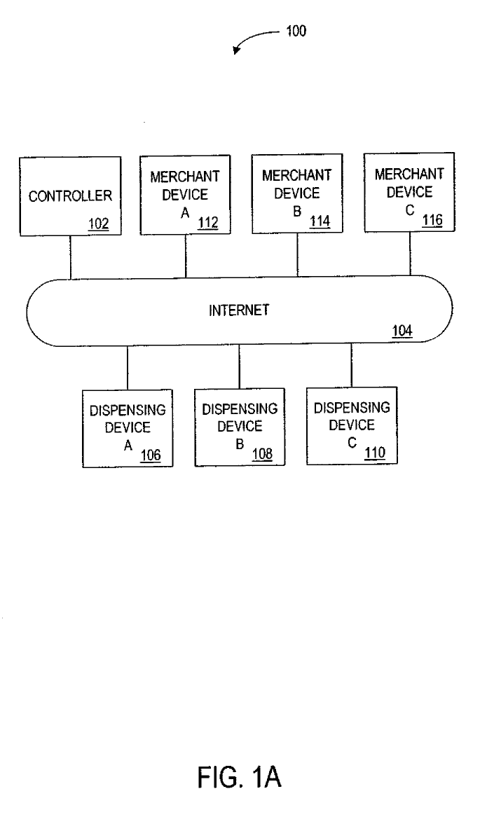

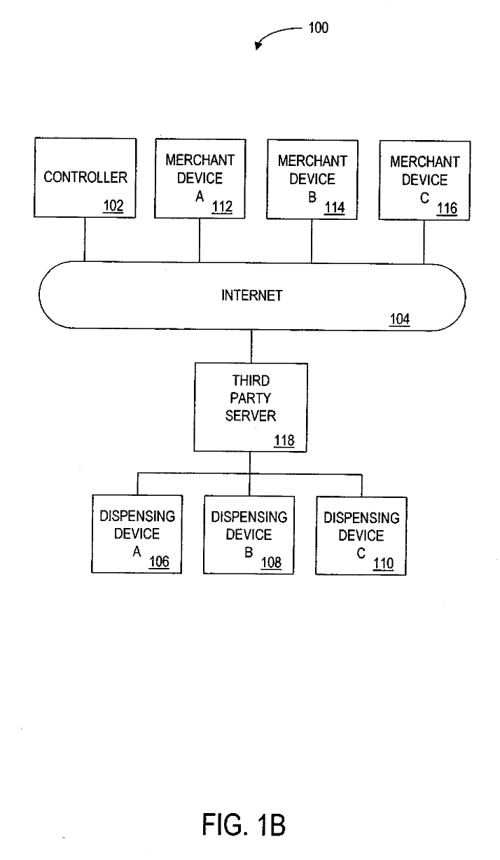

Referring now to FIG. 1A, a system 100 according to some embodiments of the present invention includes a controller 102 that is in one or two-way communication via the Internet 104 (or other communications link) with one or more dispensing devices 106, 108, 110, and/or merchant devices 112, 114, 116. In operation, the controller 102 may function under the control of a merchant or other entity that may also control the dispensing devices 106, 108, 110. For example, the controller 102 may be a server in a bank's ATM network, a slot server in a casino's gaming device network, or a server in a merchant's vending machine network. In some embodiments, the controller and the dispensing device may be one and the same.

Referring to FIG. 1B, an alternative system 100 according to some other embodiments of the present invention further includes one or more third party servers 118. A third-party server 118 may also be in one or two-way communication with the controller 102. However, as shown in the embodiment depicted in FIG. 1B, the third-party server 118 may be disposed between the controller 102 and the dispensing devices 106, 108, 110.

The primary difference between the two alternative embodiments depicted in FIGS. 1A and 1B is that the embodiment of FIG. 1B includes the third-party server 118 which may be operable by an entity both distinct and physically remote from the entity operating the controller 102. The third party server 118 may perform the methods of the present invention by sending signals to the controller 102 to be relayed to the dispensing devices 106, 108, 110. For example, an airline company may operate a third party server 118 that communicates with a bank server (functioning as a controller 102) to provide consumers cash via ATMs (functioning as dispensing devices 106, 108, 110) in exchange for committing to traveling with the airline. In the embodiment of FIG. 1A, the functions of the third-party server 118 are consolidated into the controller 102.

An additional difference between these two embodiments relates to the physical topology of the system 100. In both of the embodiments, each node may securely communicate with every other node in the system 100 via, for example, a virtual private network (VPN). Thus, all nodes may be logically connected. However, the embodiment depicted in FIG. 1B allows the third party server 118 to serve as a single gateway between the nodes that will typically be operated by the owner of the dispensing devices 106, 108, 110 (and the owner's customers) and the other nodes in the system 100, i.e. nodes that may be operated by merchants.

In some embodiments, the merchant devices 112, 114, 116 may each be controlled by different merchants. The controller 102 may be operated by an entity that uses the present invention to, for example, deliver customers to the different merchants. If there is a third party server 118, it may be operated by an unrelated entity that merely permits the operators of the controller 102 to have access to consumers who are operating the dispensing devices 106, 108, 110. Thus, in such an example embodiment, the system of the present invention may involve merchants (operating merchant devices 112, 114, 116), a customer acquisition service agent (operating the controller 102), third party network operators (operating third party servers 118), and consumers (operating dispensing devices 106, 108, 110). In alternative embodiments, a merchant may operate a combined controller/dispensing device directly and the system may only involve a merchant and a consumer.

In both embodiments pictured in FIGS. 1A and 1B, communication between the controller 102 and the merchant devices 112, 114, 116, the dispensing devices 106, 108, 110, and/or the third party server 118, may be direct and/or via a network such as the Internet 104.

Referring to both FIGS. 1A and 1B each of the controller 102, the third party server 118, the merchant devices 112, 114, 116, and the dispensing devices 106, 108, 110 may comprise computers, such as those based on the Intel® Pentium® processor, that are adapted to communicate with each other. Any number of third party servers 118, merchant devices 112, 114, 116, and/or dispensing devices 106, 108, 110 may be in communication with the controller 102. In addition, the dispensing devices 106, 108, 110 may be in one or two-way communication with the merchant devices 112, 114, 116. The controller 102, the third-party server 118, the merchant devices 112, 114, 116, and the dispensing devices 106, 108, 110 may each be physically proximate to each other or geographically remote from each other. The controller 102, the third-party server 118, the merchant devices 112, 114, 116, and the dispensing devices 106, 108, 110 may each include input devices (not pictured) and output devices (not pictured).

As indicated above, communication between the controller 102, the third-party server 118, the merchant devices 112, 114, 116, and the dispensing devices 106, 108, 110 may be direct or indirect, such as over an Internet Protocol (IP) network such as the Internet 104, an intranet, or an extranet through a web site maintained by the controller 102 (and/or the third-party server 118) on a remote server or over an on-line data network including commercial on-line service providers, bulletin board systems, routers, gateways, and the like. In yet other embodiments, the devices may communicate with the controller 102 over local area networks including Ethernet, Token Ring, and the like, radio frequency communications, infrared communications, microwave communications, cable television systems, satellite links, Wide Area Networks (WAN), Asynchronous Transfer Mode (ATM) networks, Public Switched Telephone Network (PSTN), other wireless networks, and the like.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet 104 may not transmit data to the other device for weeks at a time.

The controller 102 (and/or the third-party server 118) may function as a “web server” that presents and/or generates web pages which are documents stored on Internet-connected computers accessible via the World Wide Web using protocols such as, e.g., the hyper-text transfer protocol (“HTTP”). Such documents typically include one or more hyper-text markup language (“HTML”) files, associated graphics, and script files. A web server allows communication with the controller 102 in a manner known in the art. The merchant devices 112, 114, 116 and the dispensing devices 106, 108, 110 may use a web browser, such as NAVIGATOR® published by NETSCAPE® for accessing HTML forms generated or maintained by or on behalf of the controller 102 and/or the third-party server 118.

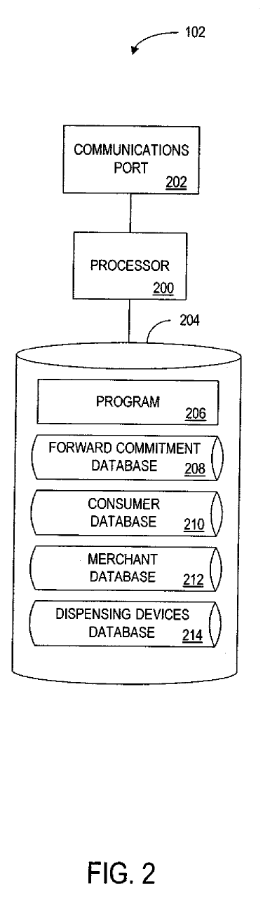

As indicated above, any or all of the controller 102, the third-party server 118, the merchant devices 112, 114, 116 and the dispensing devices 106, 108, 110 may include, e.g., processor based cash registers, telephones, interactive voice response (IVR) systems such as the M400-IVR designed by MISSING LINK INTERACTIVE VOICE RESPONSE SYSTEMS, cellular/wireless phones, vending machines, pagers, personal computers, portable types of computers, such as a laptop computer, a wearable computer, a palm-top computer, a hand-held computer, and/or a Personal Digital Assistant (“PDA”). Further details of the controller 102, the third-party server 118, the merchant devices 112, 114, 116 and the dispensing devices 106, 108, 110 are provided below with respect to FIGS. 2 through 4.

As indicated above, in some embodiments of the invention the controller 102 (and/or the third-party server 118) may include merchant devices 112, 114, 116, and/or dispensing devices 106, 108, 110. Further, the controller 102 may communicate with merchants directly instead of through the merchant devices 112, 114, 116. Likewise, the controller 102 may communicate with consumers directly instead of through the dispensing devices 106, 108, 110. Although not pictured, the controller 102, the third-party server 118, the merchant devices 112, 114, 116, and the dispensing devices 106, 108, 110 may also be in communication with one or more consumer and/or merchant credit institutions to effect transactions and may do so directly or via a secure financial network such as the Fedwire network maintained by the United States Federal Reserve System, the Automated Clearing House (hereinafter “ACH”) Network, the Clearing House Interbank Payments System (hereinafter “CHIPS”), or the like.

In operation, the merchant devices 112, 114, 116 and/or the dispensing devices 106, 108, 110 may exchange information about the consumer and the forward commitment agreement via the controller 102. In embodiments with a third-party server 118, the merchant devices 112, 114, 116 and/or the dispensing devices 106, 108, 110 may exchange information about the consumer and commitment agreement via the third-party server 118. The merchant devices 112, 114, 116 may for example, provide rules related to offering benefits or other information to the controller 102 (and/or the third-party server 118). The dispensing devices 106, 108, 110 may provide consumer obligation information to the controller 102 (and/or the third-party server 118). The controller 102 (and/or the third-party server 118) may provide information about executed forward commitment agreements to the merchant devices 112, 114, 116 and also control signals to the dispensing devices 106, 108, 110 directing them to present benefits to consumers.

C. Devices

FIG. 2 is a block diagram illustrating details of an example of the controller 102 of FIG. 1A (and/or the third-party server 118 of FIG. 11B). The controller 102 is operative to manage the system and execute the methods of the present invention. The controller 102 may be implemented as one or more system controllers, one or more dedicated hardware circuits, one or more appropriately programmed general purpose computers, or any other similar electronic, mechanical, electro-mechanical, and/or human operated device. For example, in FIG. 1B, the controller 102 is depicted as coupled to a third-party server 118. In the embodiment of FIG. 1B, these two servers may provide the same functions as the controller 102 alone in the embodiment of FIG. 1A.

The controller 102 (and/or the third-party server 118) may include a processor 200, such as one or more Intel® Pentium® processors. The processor 200 may include or be coupled to one or more clocks or timers (not pictured), which may be useful for determining information relating to, for example, whether a forward commitment is fulfilled within a specified time, and one or more communication ports 202 through which the processor 200 communicates with other devices such as the merchant devices 112, 114, 116, the dispensing devices 106, 108, 110 and/or the third-party server 118. The processor 200 is also in communication with a data storage device 204. The data storage device 204 includes an appropriate combination of magnetic, optical and/or semiconductor memory, and may include, for example, additional processors, communication ports, Random Access Memory (“RAM”), Read-Only Memory (“ROM”), a compact disc and/or a hard disk. The processor 200 and the storage device 204 may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments for example, the controller 102 may comprise one or more computers (or processors 200) that are connected to a remote server computer operative to maintain databases, where the data storage device 204 is comprised of the combination of the remote server computer and the associated databases.

The data storage device 204 stores a program 206 for controlling the processor 200. The processor 200 performs instructions of the program 206, and thereby operates in accordance with the present invention, and particularly in accordance with the methods described in detail herein. The present invention can be embodied as a computer program developed using an object oriented language that allows the modeling of complex systems with modular objects to create abstractions that are representative of real world, physical objects and their interrelationships. However, it would be understood by one of ordinary skill in the art that the invention as described herein can be implemented in many different ways using a wide range of programming techniques as well as general purpose hardware systems or dedicated controllers. The program 206 may be stored in a compressed, uncompiled and/or encrypted format. The program 206 furthermore may include program elements that may be generally useful, such as an operating system, a database management system and “device drivers” for allowing the processor 200 to interface with computer peripheral devices. Appropriate general purpose program elements are known to those skilled in the art, and need not be described in detail herein.

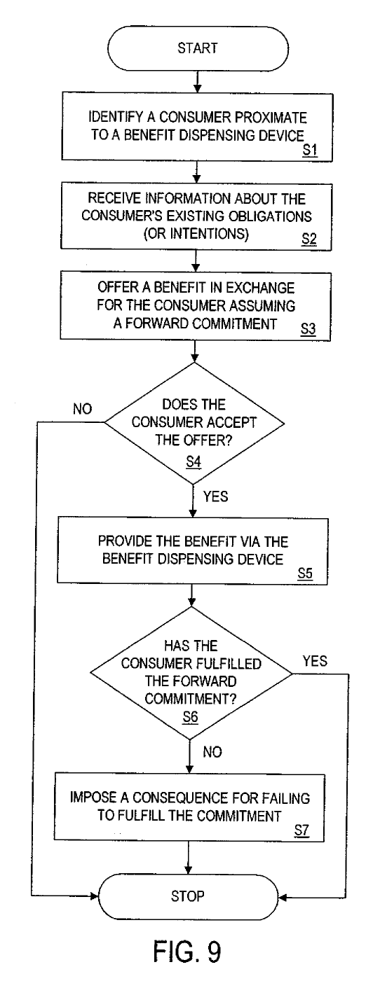

Further, the program 206 is operative to execute a number of invention-specific modules or subroutines including but not limited to one or more routines to identify a consumer at a dispensing device 106, 108, 110 as a potential candidate to be offered a forward commitment agreement; one or more routines to receive information about a consumer; one or more routines to offer a benefit to a consumer; one or more routines to determine if a consumer accepts a forward commitment offer; one or more routines to signal dispensing devices 106, 108, 110 to dispense a benefit upon a consumer's assumption of a forward commitment; one or more routines to verify a consumer's fulfillment of the forward commitment; one or more routines to impose a consequence upon a consumer who fails to fulfill a commitment; one or more routines to facilitate and control communications between merchant devices 112, 114, 116, dispensing devices 106, 108, 110, the controller 102, and/or a third party server 118; and one or more routines to control databases or software objects that track information regarding consumers, merchants, third parties, dispensing devices 106, 108, 110, inventory, benefits, forward commitments, and fulfillment. Examples of these routines and their operation are described in detail below in conjunction with the flowchart depicted in FIG. 9.

According to some embodiments of the present invention, the instructions of the program 206 may be read into a main memory of the processor 200 from another computer-readable medium, such from a ROM to a RAM. Execution of sequences of the instructions in the program 206 causes processor 200 to perform the process steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software.

In addition to the program 206, the storage device 204 is also operative to store (i) a forward commitment database 208, (ii) a consumer database 210, (iii) a merchant database 212, and (iv) a dispensing devices database 214. The databases 208, 210, 212, 214 are described in detail below and example structures are depicted with sample entries in the accompanying figures. As will be understood by those skilled in the art, the schematic illustrations and accompanying descriptions of the sample databases presented herein are exemplary arrangements for stored representations of information. Any number of other arrangements may be employed besides those suggested by the tables shown. For example, even though four separate databases are illustrated, the invention could be practiced effectively using one, two, three, five, six, or more functionally equivalent databases. Similarly, the illustrated entries of the databases represent exemplary information only; those skilled in the art will understand that the number and content of the entries can be different from those illustrated herein. Further, despite the depiction of the databases as tables, an object based model could be used to store and manipulate the data types of the present invention and likewise, object methods or behaviors can be used to implement the processes of the present invention. These processes are described below in detail with respect to FIG. 9.

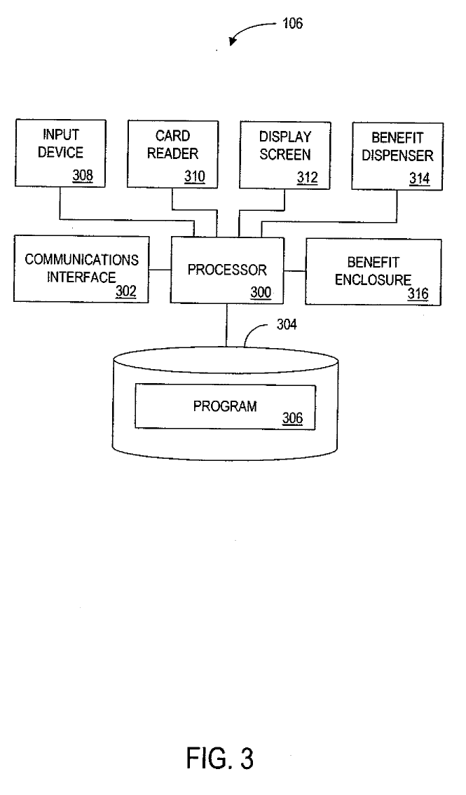

Turning to FIG. 3, a block diagram of an example dispensing device 106 is depicted. A dispensing device 106 according to the present invention may include a processor 300 coupled to a communications interface 302, a data storage device 304 that stores a dispensing device program 306, an input device 308, a card reader device 310, a display screen 312, and a benefit dispenser 314. A dispensing device program 306 may include one or more routines to facilitate and control communications and interaction with the controller 102 as well as a user interface to facilitate communications and interaction with a consumer.

In addition, a dispensing device 106 may include additional devices to support other functions. For example, a dispensing device 106 embodied in an ATM may additionally include a system for receiving, counting, and dispensing cash as well as a printing device for generating a receipt and/or a security camera. In another example, a dispensing device 106 embodied in a gaming device may additionally include a system for generating and/or selling outcomes certified by a gaming authority. Such systems include slot machines which include conventional reel slot machines, video slot machines, video poker machines, video keno machines, video blackjack machines, and other gaming machines. In yet another example, a dispensing device 106 embodied in a gasoline pump may additionally include a system for pumping, measuring, and managing the flow control of fuel. Further, many alternative input and output devices may be used in place of the various devices pictured in FIG. 3. Uses of these dispensing device 106 components are discussed below in conjunction with the description of the methods of the present invention.

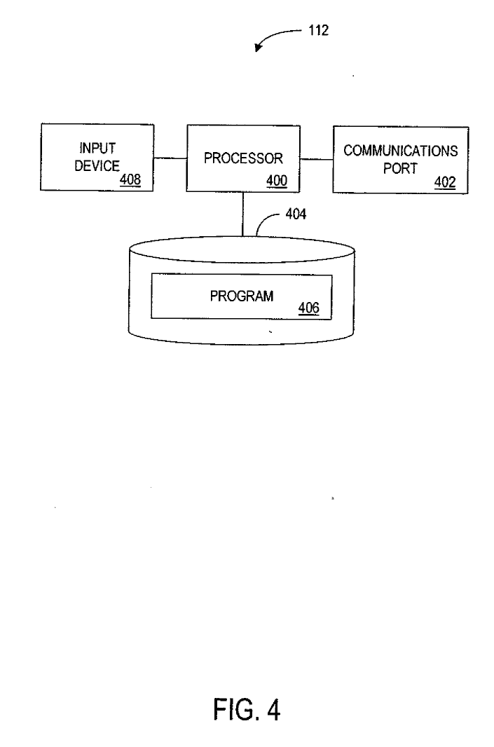

Turning to FIG. 4, a block diagram of an example merchant device 112 is depicted. A merchant device 112 according to the present invention may include a processor 400 coupled to a communications port 402, a data storage device 404 that stores a merchant device program 406, and an input device 408. A merchant device program 406 may include one or more routines to facilitate and control communications and interaction with the controller 102 as well as a user interface to facilitate communications and interaction with a merchant or a merchant's computing systems. As indicated in FIG. 4, a merchant device 112 may be implemented by any number of devices such as, for example, a processor based cash register, a telephone, an IVR system, a cellular/wireless phone, a vending machine, a pager, a personal computer, a portable computer such as a laptop, a wearable computer, a palm-top computer, a hand-held computer, a PDA, and/or a device that combines any or all functions of these devices, such as, for example, the Treo® by Handspring®.

D. Databases

As indicated above, it should be noted that although the example embodiment of FIG. 2 is illustrated to include four particular databases stored in storage device 204, other database arrangements may be used which would still be in keeping with the spirit and scope of the present invention. In other words, the present invention could be implemented using any number of different database files or data structures, as opposed to the four depicted in FIG. 2. Further, the individual database files could be stored on different servers (e.g. located on different storage devices in different geographic locations, such as on a third-party server 118). Likewise, the program 206 could also be located remotely from the storage device 204 and/or on another server. As indicated above, the program 206 includes instructions for retrieving, manipulating, and storing data in the databases 208, 210, 212, 214 as necessary to perform the methods of the invention as described below.

1. Forward Commitment Database

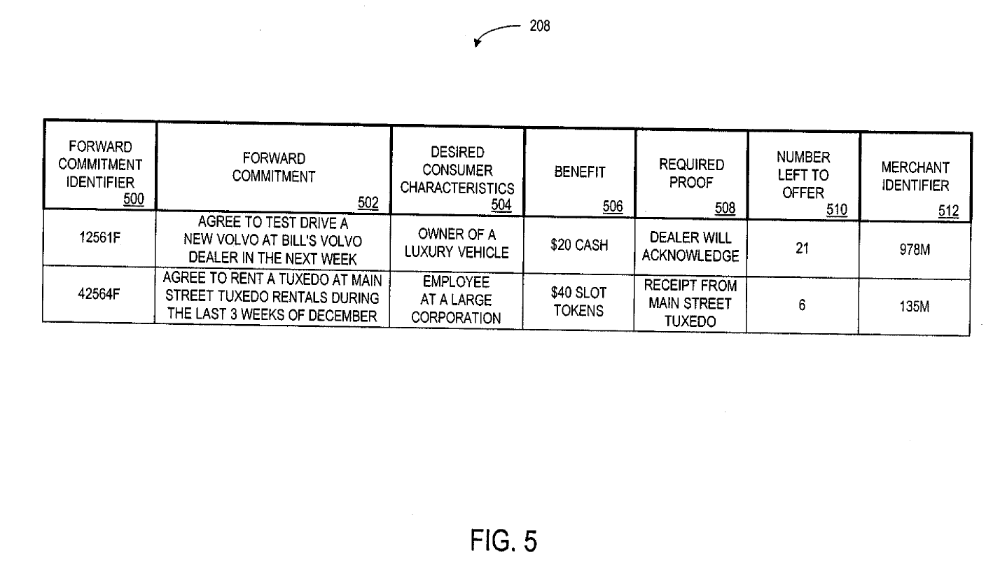

Turning to FIG. 5, a tabular representation of an embodiment of a forward commitment database 208 according to some embodiments of the present invention is illustrated. This particular tabular representation of a forward commitment database 208 includes sample records or entries which each include information regarding a particular forward commitment agreement. In some embodiments of the invention, a forward commitment database 208 is used to track such things as forward commitments, target consumer characteristics, benefits, and fulfillment requirements. Those skilled in the art will understand that such forward commitment database 208 may include any number of entries.

The particular tabular representation of a forward commitment database 208 depicted in FIG. 5 defines a number of fields for each of the entries or records. The fields may include: (i) a forward commitment identifier field 500 that stores a representation uniquely identifying the forward commitment agreement; (ii) a forward commitment field 502 that stores a representation of a description of the forward commitment associated with the commitment agreement; (iii) a desired consumer characteristics field 504 that stores a representation of a description of the characteristics the merchant desires in a consumer; (iv) a benefit field 506 that stores a representation of a description of a benefit associated with the commitment agreement; (v) a required proof field 508 that stores a representation of a description of what is required to prove that the forward commitment has been fulfilled; (vi) a “number left to offer” field 510 that stores a representation of the number of forward commitment agreements remaining that the merchant is willing to offer; and (vii) a merchant identifier field 512 that stores a representation uniquely identifying the merchant offering the forward commitment agreement.

The example forward commitment database 208 depicted in FIG. 5 provides example data to illustrate the meaning of the information stored in this database embodiment. A forward commitment identifier 500 (e.g. “12561F”, “42564F”) may be used to identify and index the forward commitment agreements listed in the forward commitment database 208. Two examples of forward commitments are provided in the forward commitment field 502. The first, “Agree to test drive a new Volvo at Bill's Volvo Dealer in the next week,” is an example of a forward commitment to sample a product. The second, “Agree to rent a tuxedo at Main Street Tuxedo Rental during the last three weeks of December,” is an example of a forward commitment to rent a product. As defined above, a forward commitment includes a commitment to do one or more of the following: purchase, use, lend, borrow, sell, lease, and/or license a product; perform work; provide an opinion; make a donation or contribution; and/or answer a question Note that both examples in FIG. 5 also include a time period requirement. Thus, in either case, if the commitment is not fulfilled by a certain date, the system of the present may determine that the consumer has breached the forward commitment agreement and may impose a consequence. The desired consumer characteristics field 504 lists examples of the type of customer the merchant desires to reach and the benefit field 506 indicates how much the merchant is will to spend to do so.

In the first sample entry, the merchant (Bill's Volvo Dealer, merchant identifier 512 “978M”) offering the first-listed forward commitment agreement has determined that it is worth $20.00 to have an “owner of a luxury vehicle” test drive a new Volvo. The required proof field 508 indicates that Bill's Volvo Dealership will acknowledge to the system 100 that the consumer fulfilled the forward commitment. The “number left to offer” field 510 indicates that Bill's Volvo Dealership is willing to offer this forward commitment agreement to twenty-one additional owners of luxury vehicles.

In the second sample entry, the merchant (Main Street Tuxedo Rental, merchant identifier 512 “135M”) offering the second-listed forward commitment agreement has determined that it is worth $40.00 in slot tokens to have an “employee at a large corporation” rent a tuxedo towards the end of December. The required proof field 508 indicates that a receipt from Main Street Tuxedo Rental will be required to prove to the system 100 that the consumer fulfilled the forward commitment. The “number left to offer” field 510 indicates that Main Street Tuxedo Rental is willing to offer this forward commitment agreement to six additional employees at large corporations. In an alternative embodiment, in place of a “number left to offer” field 510, a “budget” field may be used that tracks an amount of money that remains to be spent (in terms of promotional or marketing dollars) on the particular forward commitment agreement. The merchant may define a cost per forward commitment agreement to use such a budget field.

2. Consumer Database

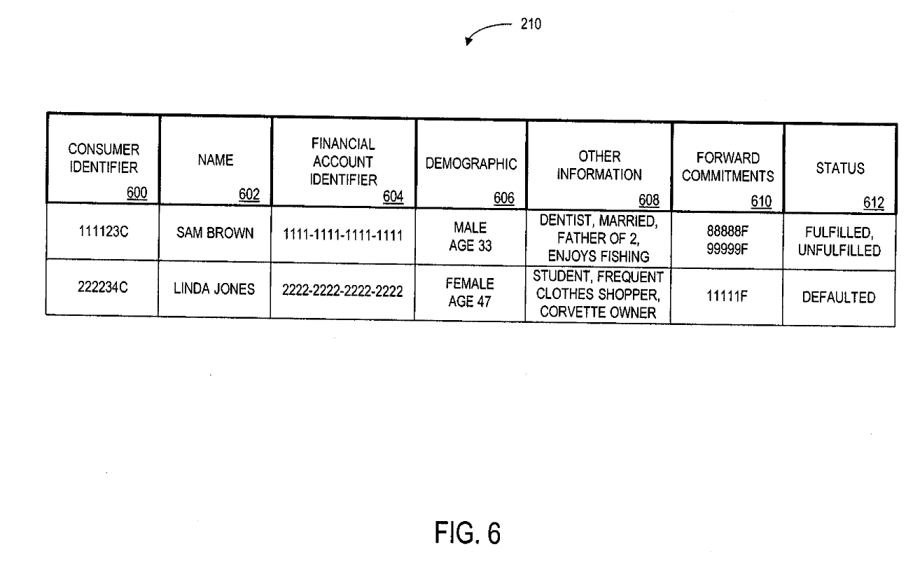

Turning to FIG. 6, a tabular representation of an embodiment of consumer database 210 according to some embodiments of the present invention is illustrated. This particular tabular representation of a consumer database 210 includes two sample records or entries which each include information regarding a particular consumer. In some embodiments of the invention, a consumer database 210 is used to track consumer information such as the consumer's name, financial account information, demographic description, forward commitment agreements accepted and their fulfillment status. Those skilled in the art will understand that such a consumer database 210 may include any number of entries.

The particular tabular representation of a consumer database 210 depicted in FIG. 6 defines a number of fields for each of the entries or records. The fields may include: (i) a consumer identifier field 600 that stores a representation uniquely identifying a particular consumer; (ii) a name field 602 that stores a representation of the consumer's name; (iii) a financial account identifier field 604 that stores a representation of a bank, credit card, or other financial account number for charging the consumer if he defaults on the commitment agreement; (iv) a demographic field 606 that stores a representation of a description of demographic characteristics of the consumer for identifying consumers with desired characteristics to whom forward commitment agreements may be offered; (v) an “other information” field 608 that stores a representation of a description of additional information about the consumer (also for identifying consumers with desired characteristics to whom forward commitment agreements may be offered); (vi) a forward commitments field 610 that stores a representation of the forward commitment agreements that the consumer has entered into in the form of forward commitment identifiers 500; and (vii) a status field 612 that stores a representation of the current state of fulfillment (fulfilled, unfulfilled, or defaulted) of the commitment.

The example consumer database 210 of FIG. 6 provides example data to illustrate the meaning of the information stored in this database embodiment. A consumer identifier 600 (i.e. 111123C, 222234C) may be used to identify and index consumers who have entered into a forward commitment agreement.

The first sample entry describes a consumer named “Sam Brown,” who has a credit card account number “1111-1111-1111-1111,” and is “male, age 33.” He is a “dentist, married, father of 2, [and] enjoys fishing.” According to the forward commitments field 610 and the status field 612, Sam Brown has entered into two forward commitment agreements “88888F” and “99999F” of which he has fulfilled the first and not yet fulfilled the second.

The second sample entry describes a consumer named “Linda Jones,” who has a credit card account number “2222-2222-2222-2222,” and is “female, age 47.” She is a “student, frequent clothes shopper, [and a] Corvette owner.” According to the forward commitments field 610 and the status field 612, Linda Jones has entered into one forward commitment agreement “11111F” and has defaulted on fulfilling the commitment.

3. Merchant Database

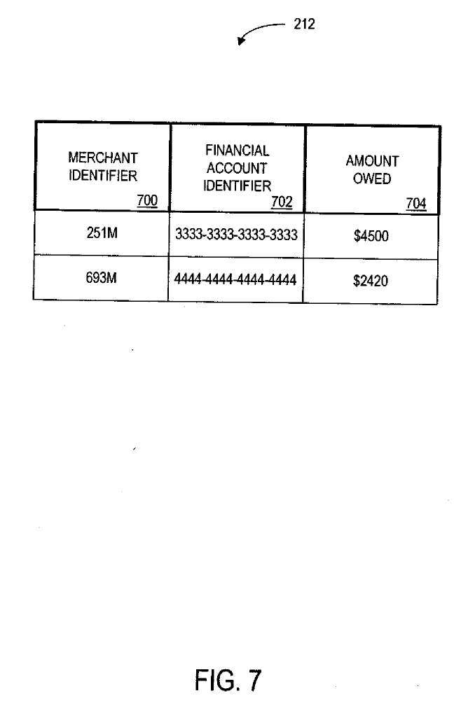

Turning to FIG. 7, a tabular representation of an embodiment of a merchant database 212 according to some embodiments of the present invention is illustrated. This particular tabular representation of a merchant database 212 includes two sample records or entries which each include information regarding a particular merchant. In some embodiments of the invention, a merchant database 212 is used to track information about the merchants including financial account information and the amount the merchant owes to cover the costs of providing benefits to consumers. Those skilled in the art will understand that such a merchant database 212 may include any number of entries.

The particular tabular representation of a merchant database 212 depicted in FIG. 7 defines a number of fields for each of the entries or records. The fields may include: (i) a merchant identifier field 700 that stores a representation uniquely identifying the merchant; (ii) a financial account identifier field 702 that stores a representation of a bank, credit card, or other financial account number for charging the merchant for providing benefits to consumers; and (iii) an amount owed field 704 that stores a representation of the amount the merchant owes for providing benefits to consumers.

The example merchant database 212 of FIG. 7 provides example data to illustrate the meaning of the information stored in this database embodiment. A merchant identifier 700 (e.g. 251M, 693M) may be used to identify and index the different merchants listed in the merchant database 212. The records may include a financial account identifier (represented by an account number, e.g. “3333-3333-3333-3333,” “4444-4444-4444-4444”) that may be specified to facilitate billing or actually charging merchants for services rendered, i.e. delivering new customers and providing benefits. Finally, the records may store accounting information such as amounts owed by the merchants (e.g. “$4500,” “$2420”) for services rendered to the merchants.

4. Dispensing Devices Database

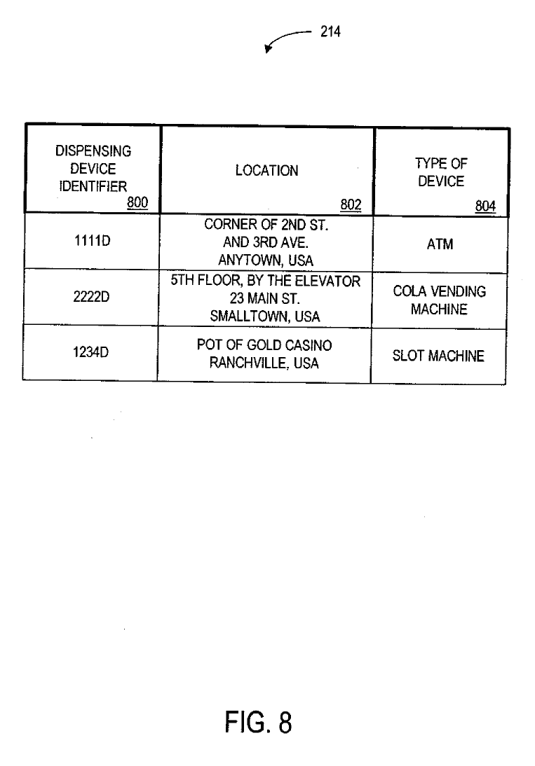

Turning to FIG. 8, a tabular representation of an embodiment of a dispensing devices database 214 according to some embodiments of the present invention is illustrated. This particular tabular representation of a dispensing devices database 214 includes three sample records or entries which each include information regarding a particular benefit dispensing device. In some embodiments of the invention, a dispensing devices database 214 is used to track such things as the type and location of each benefit dispensing device. Those skilled in the art will understand that a dispensing devices database 214 may include any number of entries.

The particular tabular representation of a dispensing devices database 214 depicted in FIG. 8 defines a number of fields for each of the entries or records. The fields may include: (i) a dispensing device identifier field 800 that stores a representation uniquely identifying at least one benefit dispensing device; (ii) a location field 802 that stores a representation identifying where the dispensing device is currently located; and (iii) a type of device field 804 that stores a representation describing what additional functions the dispensing device may have.

The example dispensing devices database 214 of FIG. 8 provides example data to illustrate the meaning of the information stored in this database embodiment. A dispensing device identifier 800 (e.g. 1111D, 2222D, 1234D) may be used to identify and index the different dispensing devices listed in the dispensing device database 214. The location field 802 and the type of device field 804 may provide a description that allows a merchant to decide, for example, to choose where he would prefer to acquire customers. In the first sample entry, an ATM dispensing device is located at a street intersection. In the second sample entry, a cola vending machine dispensing device is located in a building on Main Street and in the third sample entry, a slot machine dispensing device is located within a casino building. These different types of machines, in different locations, may provide merchants access to different types of consumers with different motivations and obligations. Further, the different machines may provide different benefits. For example, a cola vending machine dispensing device in a downtown building may offer a free soda to an office worker willing to commit to buying his lunch at a local deli while a slot machine dispensing device may offer free plays to a vacationer willing to switch his current lodging choice to the casino's hotel.

E. Process Descriptions

The system discussed above, including the hardware components and the databases, are useful to perform the methods of the invention. However, it should be understood that not all of the above described components and databases are necessary to perform any of the present invention's methods In fact, in some embodiments, none of the above described system is required to practice the invention's methods. The system described above is an example of a system that would be useful in practicing the invention's methods. For example, the consumer database 210 described above is useful for tracking customers and information about them, but it is not absolutely necessary to have such a database in order to perform the methods of the invention. In other words, the methods described below may be practiced using a conventional customer list in conjunction with a transaction log.

Referring to FIG. 9, a flow chart is depicted that represents some embodiments of the present invention that may be performed by the controller 102 (FIGS. 1A and 1B), an external third party, and/or an integrated third party entity/device such as a third-party server 118. It must be understood that the particular arrangement of elements in the flow chart of FIG. 9, as well as the order of example steps of various methods discussed herein, is not meant to imply a fixed order, sequence, and/or timing to the steps; embodiments of the present invention can be practiced in any order, sequence, and/or timing that is practicable.

In general terms and referring to FIG. 9, the method steps of the present invention may be summarized as follows. In Step S1, the system 100 identifies a consumer proximate to a benefit dispensing device. In Step S2, information about the consumer is received. In Step S3, a forward commitment agreement is presented to the consumer. In Step S4, an indication that the consumer agrees to enter into the forward commitment agreement is received. In Step S5, the benefit dispensing device is signaled to provide the benefit to the consumer. In Step S6, it is determined if the consumer fulfilled the commitment, and in Step S7, a consequence is imposed if the consumer has not fulfilled the commitment.

In the subsections that follow, each of these seven steps will now be discussed in greater detail. Note that not all of these seven steps are required to perform the method of the present invention and that additional and/or alternative steps are also discussed below. Also note that the above general steps represent features of only some of the embodiments of the present invention and that they may be combined and/or subdivided in any number of different ways so that the method includes more or fewer actual steps. For example, in some embodiments many additional steps may be added to update and maintain the databases described above, but as indicated, it is not necessary to use the above described databases in all embodiments of the invention. In other words, the methods of the present invention may contain any number of steps that are practicable to implement the processes described herein. The methods of the present invention are now discussed in detail.

1. Identify a Consumer Proximate to a Benefit Dispensing Device

In Step S1, a consumer near a dispensing device 106 is recognized as a potential candidate for a forward commitment agreement. In some embodiments, the dispensing device 106 recognizes a consumer in its proximity by receiving a card belonging to the consumer. The card may be one corresponding to a financial account, such as a credit card or debit card. The card may also be an ATM card, a player tracking card and/or a frequent shopper card. The dispensing device 106 may recognize a consumer through the consumers transacting or interacting with the device. For example, a vending machine senses that coins are deposited and a beverage is selected. A consumer may press a button simply to indicate his presence to the dispensing device 106. Consumers may also be identified using voice recognition, infrared detection, motion detection, image recognition, and so on. In some embodiments, a human associate of the dispensing device 106 may identify people and indicate to the dispensing device 106 when a consumer has become proximate to the dispensing device 106. In other embodiments, a consumer's PDA, cell phone, or other device may alert the dispensing device 106 to the consumer's proximity using, for example, a wireless protocol (such as Bluetooth as described at http://www.bluetooth.com/developer/specification/specification.asp). Once identified, a consumer's identifying information may be stored in a database such as, for example, the consumer database 210 of FIG. 6.

2. Receive Information about the Consumer

In Step S2, the system 100 receives information via the input device 308 and/or the card reader 310 of the dispensing device 106 about the consumer to determine what kind of forward commitment may be acceptable to him. In some embodiments, the system 100 may retrieve information about the consumer from its own databases and/or other online databases maintained by third parties such as credit reporting bureaus, for example. In some embodiments the consumer information is also useful for determining benefits that would be appealing to the consumer. A consumer's existing obligations provide a useful insight into what the consumer may already be planning to do, and thus, may be helpful in identifying a forward commitment that the consumer may choose to accept.

A consumer's existing obligations describe actions a consumer may feel some pressure to perform. The pressure may come out of physical necessity. For example, a consumer is ultimately obligated to cat and to sleep. Obligations may stem from social pressure. For example, a consumer is obligated to sleep in some private setting rather than on a park bench or doorstep. Thus, a consumer away from home may be obligated to stay at a hotel. Obligations may also arise from financial pressure, peer pressure, from a promise made, from moral duty, from fear, from pride, and so on. Typical consumer obligations may include eating out at a restaurant, flying to a destination, filling a car with gas, getting a car's oil changed, fixing a car's dented bumper, opening a checking account, getting a new credit card, getting an annual physical examination, buying cereal, getting a hotel room for the night, sending a child to summer camp, finding a baby-sitter, getting a shirt mended, hiring a lawn-mowing service, getting a hairdo, filling tax returns, and taking a pet for vaccinations.

In addition to obligations, a consumer may disclose one or more intentions of interest to the benefit dispensing device 106. For example, a consumer may indicate that he intends to take a vacation, though he may not be obligated to do so.

After being prompted, or of his own volition, a consumer may communicate his obligations and intentions to the dispensing device 106. Communication may occur through keys, touch screens, voice input, wireless technology, or any other mode. The consumer may also communicate proof or evidence of an obligation, such as a code that confirms a hotel reservation in a person's name. The consumer may, in addition, communicate other personal information, such as a name, demographic description, address, purchasing history, hobbies, profession, and so on. Any such information may then be stored in a database such as, for example, the consumer database 210 depicted in FIG. 6.

In obtaining information about a consumer, the dispensing device may engage the consumer in a survey. The survey may be interactive-determining new questions based on answers to prior ones. The survey may be designed to elicit characteristics of a consumer that help determine if he is either suitable or unsuitable for a forward commitment. Thus, if a consumer mentions he is a Mercedes owner in response to a first question, a second question may ask whether he lives near a particular luxury-car dealership. In this way, a consumer may be scrutinized as a candidate for a forward commitment requiring a test-drive of a new Audi® at a particular dealer.

A consumer may record obligations on a user device such as a PDA. This may occur with customary use of such devices, as with a consumer's appointment calendar, address book, and/or shopping list. An appointment calendar may not always include appointments per se, but may include, for example, notices of friends' birthdays, with the implicit reminder to buy a card or a gift. These obligations may then be accessed by the controller 102 (and/or the third party server 118) via a dispensing device 106 that is in communication with the user device. For example, if a consumer has listed an appointment in his PDA to “Meet Jan at the Woolworth building at 3:00 PM on May 21” and the consumer grants an ATM-type dispensing device 106 permission to access his PDA's data, the consumer's PDA may communicate that appointment data, via e.g. infrared transmissions, to the ATM dispensing device 106. The ATM dispensing device 106 may then transmit the appointment information to the controller 102. As will be discussed below with regard to other steps of the methods of the invention, an operator and/or a computer program 206 may interpret the meaning of the appointment data received by the controller 102. In view of the appointment data, the controller 102 may present a forward commitment agreement to the consumer, via the ATM, whereby the consumer may choose to commit to using a particular cab company to reach the Woolworth building on May 21.

In some embodiments, a consumer may choose to record intentions and/or obligations on his user device expressly for the purpose of allowing the controller to become aware of his intentions and/or obligations. This may be the case even when the record of the intentions and/or obligations serve no reminder purpose for the consumer himself.

Thus, the receipt of information regarding a consumer's obligations, intentions and other information may allow the system 100 of the invention to provide benefits tailored to a particular consumer and to determine commitments that the consumer may be predisposed to accept.

3. Present a Forward Commitment Agreement to the Consumer

In Step S3, the controller 102 (and/or the third party server 118) determines a benefit, a forward commitment, and optionally a consequence to present via the dispensing device 106 to the consumer as a forward commitment agreement.

(i) Identify a Benefit Based on the Information about the Consumer

Benefits may include: cash, equity, options, gambling tokens, stamps, tickets, consumable products, toys, other products, services, insurance policies, and honorary titles. Products may be in the form of information such as music and video recordings, driving directions, a person's weight, etc. Entertainment products, such as music videos may be displayed directly on the dispensing device 106, or transferred in binary form, to a consumer's PDA. Benefits may include product add-ons, such as warranties. Services may include: clothes washing, car washing, etc. Identifying a benefit may entail deciding whether to offer a benefit at all.

For a gaming device-type dispensing device in particular, benefits may include: cash; credits; gambling tokens; reward points; cashless gambling receipts; increased odds of winning; increased prize tables; insurance against losses; the ability to play a large denomination machine for a small denomination; the free use of an extra slot in a multi-slot machine; being permitted to play for free; having winnings rounded to a higher level (e.g. $85 rounded to $100); the enablement of extra prize-winning symbols on a slot machine; the enablement of extra pay lines on the slot machine; discounts on various products; and auxiliary benefits, such as free or subsidized meals or hotel rooms.

A benefit to be offered a particular consumer and/or a consumer in general may be identified based on a number of factors. These factors may include: whether the benefit sufficiently motivates a consumer (and/or the present consumer) to enter into and to fulfill a forward commitment agreement; the value to the system 100 and/or to a merchant of binding the consumer in a forward commitment; the benefits the dispensing device 106 can actually physically dispense at the moment (e.g. a given vending machine may temporarily be out of stock of a particular product); revenue management principles (as detailed in a book by Robert G. Cross entitled “Revenue Management: Hard-Core Tactics for Market Domination”, Pub. 1997, by Broadway Books, which is incorporated by reference herein in its entirety); and any predefined strategy for dispensing a limited number of benefits amongst multiple potential entrants into forward commitment agreements.

Information about the consumer may reveal which benefits may be particularly motivational and when to offer the benefits. For example, a consumer at a slot machine-type dispensing device 106 who has just lost $50.00 may be quite embarrassed and therefore highly motivated to accept a $50.00 benefit for entering into virtually any reasonable forward commitment. Likewise, a consumer at an ATM-type dispensing device 106 who requests to withdraw $50.00 but has only $35.00 in his account may be motivated to accept a $15.00 cash benefit. Further, a consumer at a gas pump-type dispensing device 106 who has lost his wallet and needs gas to reach home may be motivated to accept five gallons of gasoline as a benefit.

In identifying a benefit, the controller 102, a merchant, and/or the third party server 118, may calculate the value of having a particular consumer commit to a particular forward commitment, and may then offer a portion of that value to the consumer as a benefit. For example, a credit card company might calculate that it makes an average of $300.00 from every female card-holder over the duration of the card-holder's business with the credit card company. The credit card company may thus choose to offer $150.00 dollars to a consumer using a vending machine-type dispensing device 106 located in a woman's locker room in exchange for committing to sign up with the company. The credit card company may choose to extend such an offer based on anticipating a $150.00 profit resulting from signing up the consumer (less any fee provided to the system 100). Having determined the value of the average female customer, the credit card company may notably choose to never offer more than a $300.00 benefit to an individual woman unless special circumstances are involved.

In a casino setting, the controller 102 might calculate the value of having a gambler play on a gaming device for an extra hour. The calculation may be based on the gambler's rate of play and on the hold percentage of the gaming device. A gaming device's “hold percentage” is defined as one minus the ratio of the number of coins paid to the number of coins collected in wagers over a complete cycle of the gaming device. An exemplary formula for the value to the casino of an extra hour's play on a “$1 machine” gaming device may be expressed as:
Value=(Rate of Play)*(1 Hour)*($1)*(Number of Coins per Pull)*(Hold Percentage)

The casino may, via a gaming device-type dispensing device 106, offer a portion of the computed value as benefit to the gambler in return for the gambler committing to playing for an extra hour.

The controller 102, a merchant, and/or the third party server 1118, may also calculate a typical customer acquisition cost. The controller 102 or merchant may then be willing to allow a dispensing device 106 to offer a benefit with value up to the cost of customer acquisition.

In some cases, the benefit offered may depend on the contents of the dispensing device 106. For example, if a slot machine-type dispensing device 106 has only $30.00 worth of coins in its hopper, the benefit offered may be constrained not to exceed $30.00. Even if a dispensing device 106 has sufficient money or products inside of it to provide a particular benefit, the contents of the machine may instead be preserved for other benefits, or for the normal use of the machine. For example, if an ATM-type dispensing device 106 has only $200.00 remaining, even small benefits may not be offered so that there will be money available for bank customers simply wishing to withdraw funds. Alternatively, small benefits may not be offered to moderately desirable consumers so that a large benefit may be offered to a highly desirable consumer. In deciding when to offer benefits, the dispensing device 106, or the controller 102/third party server 1118, may use algorithms that consider the frequency with which the device is used, the types of consumers that use the device, revenue management principles, and when and how often the contents of the device are replenished.

The determination of a benefit, including the determination to offer none at all, may further depend on a consumer's perceived trustworthiness. If a consumer is deemed only 50% likely to fulfill a commitment to sign up for a credit card, the value of the forward commitment to the credit card company may decline by 50%, and the benefit offered the consumer may be reduced accordingly.

A benefit offered to the consumer may not correspond directly to the value of the forward commitment. For example, a benefit may be disproportionately large in order to show appreciation to a loyal customer, or to earn the loyalty of a new customer.

A benefit offered to a consumer may depend on influences from a merchants' competitors. For example, a fitness club looking to acquire new members may authorize a juice vending machine-type dispensing device 106 located outside a competitor's club to offer a bottle of juice as a benefit to a consumer in return for entering into a forward commitment to exercise three times at the fitness club. The value of the benefit offered may be increased if there are numerous competing fitness clubs near the benefit dispensing device which might divert the consumer's attention.

(ii) Identify a Forward Commitment Based on the Information about the Consumer

In addition to a benefit, the system 100 will also identify a forward commitment to be fulfilled by the consumer in exchange for the benefit. As indicated above, the forward commitment identified may be based on information about the consumer's existing obligations. Merchants may periodically submit, via merchant devices 112, forward commitments to the controller 102 for subsequent offering to consumers. With the forward commitments, the merchants may include an amount of benefit to be paid to a consumer should the consumer assume the forward commitment. The merchant might further specify a fee he is willing to pay the system 100 for each consumer the system 100 enters into a forward commitment agreement. Of course, many other fee structures are possible. The merchant may further provide descriptions of consumers that the merchant desires to have enter into the forward commitments agreements. Descriptions may include age, demographic information, purchasing history, family size, height, weight, shoe size, gender, etc. Merchants may additionally specify the number of consumers they desire to enter into forward commitment agreements.

Forward commitments, benefits, fee specifications, quantity specifications, and descriptions of consumers may be stored by the system 100 in a database such as, for example, the forward commitment database 208 depicted in FIG. 5. The controller 102 may access relevant commitments from the database 208 when a suitable consumer interacts with a dispensing device 106. The controller 102 may use a rules-based system to determine an appropriate forward commitment or, in some embodiments, an operator of the controller 102 and/or merchant device 116 may determine appropriate forward commitments. In some embodiments, the forward commitments may be selected or derived using artificial intelligence.

Some specific examples of forward commitments may include: a commitment to eat at Joe's Pasta House on Oct. 6, 2003, and to spend at least $25.00; a commitment to fly from JFK airport in New York to O'Hare airport in Chicago using United Airlines®, the flight occurring in the next 60 days; a commitment to buy 10 gallons of gasoline weekly from a Mobil® station for the next 12 weeks; a commitment to open a checking account with Fleet Bank® within the next 15 days; a commitment to play at a slot machine for another hour; a commitment to a consultation with a life-insurance agent; a commitment to test drive a new car; a commitment to limit cereal purchases to Quaker® brand cereals for the next six months; and a commitment to sign up for a Chase® credit card and to transfer $1,000.00 in existing balances to the new card.

In some embodiments, a forward commitment may be determined directly based on selecting a commitment that requires the consumer to satisfy an existing obligation in a particular way. For example, if the consumer has a long drive commuting to work, and therefore purchases gasoline frequently, then the system 100 may offer the consumer a forward commitment to buy 10 gallons of gasoline per week from Mobil®. Likewise, if the consumer is in charge of planning a family reunion for next August 11 in Zenda, Kans., then the system 100 may offer the consumer a forward commitment to have the family dine at Leon's Chicken Fry of Zenda, Kans.

In some embodiments, forward commitments may be determined by examining the implications of existing obligations. For example, if a vacationer is a registered guest at a merchant's hotel for the next three nights, then it may be assumed the vacationer will be dining at local restaurants for the next three days. Thus, a vending machine-type dispensing device 106 located in the hotel lobby that offers a benefit in exchange for a forward commitment to dine at the merchant's restaurants for the next three days may be effective with the vacationer.

(iii) Identify a Consequence for not Fulfilling the Commitment

The controller 102 may optionally “penalty secure” the forward commitment. This may be implemented by retaining financial account information of the consumer. The financial account may be billed if the consumer does not fulfill the forward commitment. The amount billed may relate to the value of the benefit provided, interest on the benefit, costs associated with processing forward commitment information, and any other fees or penalties.

The consequence may restrict the consumer's access to one or more benefit dispensing devices 106. For example, if a consumer has signed up for a forward commitment through his bank's ATM-type dispensing device 106, the consequence might reduce the consumer's daily withdrawal limit from the ATM. In some embodiments, the consequence may be a ban or restriction on the consumer from entering into future forward commitments.

In some embodiments, the consequence may require the return or revocation of the benefit provided. For example, if the benefit is a product, the system 100 may require that the product be returned. The product might be returned directly to the dispensing device 1006, or to an affiliated party, such as a merchant.

In some embodiments, the controller 102 may send a warning message or letter to the consumer, encouraging him to fulfill his forward commitment and possibly warning of other consequences if he does not. The system may initiate legal action against the consumer in order to enforce the terms of the forward commitment agreement, or to recover damages incurred.

(iv) Present the Agreement to the Consumer

The offer may be presented to the consumer in many different ways including: via text displayed on an LCD or other display screen or device; via back-lighting pre-composed text; via a message sent to a consumer device, such as a PDA, via text printed on a paper, via a computer synthesized voice; via a pre-recorded voice; via a live voice; and/or via a Braille representation.

In some embodiments, offers of commitment agreements may be sent to a consumer's device (e.g. PDA) but not revealed immediately. The offers may not be revealed until the consumer has demonstrated an obligation or intention. For example, an offer of $50.00 in return for entering into a commitment to fly Delta Airlines® may only be revealed to a consumer whose PDA is set to Eastern Standard Time (EST) when the consumer enters an appointment to meet a friend in San Francisco. Offers may also be revealed based on a consumer's location. In particular, offers may be revealed if a consumer is proximate to a benefit dispensing device 106.

The offer of the forward commitment agreement may include a complete description of the forward commitment, the benefit to be provided, and any consequence or penalty to be imposed should the consumer enter into, but not fulfill the forward commitment. The offer may further include a description of the consumer's legal rights and obligations in entering into the forward commitment.

4. Receive an Indication the Consumer Accepts the Forward Commitment Agreement

In Step S4, the consumer indicates his acceptance or rejection of the offered forward commitment agreement. If the consumer rejects the offer, the process terminates. In some embodiments, the system may present an alternate offer or modify the existing offer to make it more appealing. If the consumer accepts the offer, the controller 102 signals the dispensing device 106 to provide the consumer with the benefit.

According to various different embodiments, a consumer may indicate his acceptance of a forward commitment agreement in many different ways including: pressing an “accept” or similar button on a dispensing device 106 or a touch screen of the device; verbally communicating his acceptance; signing a written document and, optionally, inserting the executed document into the dispensing device 106; signing a touch screen; providing a finger print; providing a retinal scan or other unique biometric, providing a print or a number of a credit or debit card; transmitting a written, electronic, or voice message to a phone number or address designated by the controller 102 via the dispensing device 106.

5. Provide the Benefit to the Consumer Via the Dispensing Device

In Step S5, the benefit dispensing device 106 provides the benefit, be it cash, tokens, stamps, tickets, coupons, phone time, consumables, product, information, or service in response to a signal to do so from the controller 102. The benefit may be provided via a benefit dispenser 314, such as those possessed by ATMs for dispensing cash, or those possessed by slot machines for dispensing tokens. Information may be dispensed on a machine-readable medium, such as a floppy disk or a DVD. Information may also be transmitted to a consumer device, such as a cell phone or a PDA.

6. Determine If the Consumer Fulfilled the Commitment

In Step S6, the system 100 determines whether the forward commitment has been fulfilled. If the consumer has fulfilled the forward commitment, processing stops. If not, processing proceeds to Step S7.

In some embodiments, the controller 102 may examine transaction records of the consumer. Transaction records may include a credit card billing history or a purchasing history maintained in a frequent shopper account. From these transaction records, the controller 102 may determine, for example, whether a consumer has dined at a restaurant where he had agreed to dine. One provision of the forward commitment agreement may be that the consumer grants the controller 102 access to any records that allow it to verify satisfaction of the forward commitment.

In some embodiments, the consumer may submit to the controller 102, receipts, ticket stubs, menus, UPC codes, pictures, casino tokens, or any other acceptable proof that the consumer has fulfilled his forward commitment. The failure to provide such proof within a defined time period, may be defined to be a default. In other embodiments, a merchant may call or access the controller 102 and/or the third party server to verify that the consumer has, for example, transacted with the merchant in accordance with a forward commitment agreement.

7. Impose the Consequence If the Consumer Defaulted on the Commitment Agreement

In Step S7, the controller 102 causes the consequence to be imposed upon the consumer. Thus, depending on the consequence as agreed to in the forward commitment agreement, the controller 102 may take many different actions including: billing a financial account associated with the consumer; flagging the consumer's name in a database so that the consumer is restricted from entering into fixture forward commitments; flagging the consumer's name in a database so that the consumer is restricted from using the benefit dispensing device; sending the consumer a warning message via, for example, email, fax, and/or postal mail; and initiating legal action against the consumer.

### EXAMPLE ILLUSTRATIVE EMBODIMENT OF THE INVENTION

The following example illustrates one sample embodiment of the present invention. It involves a forward commitment agreement with a consequence for defaulting and it also involves a third party server 118 that works with a controller 102 to offer the forward commitment agreement.

John Smith went to his local ATM and deposited a pay check. He was about to request his ATM card back when, on the display screen, he was presented with the following offer:
Agree to take one trip using United Airlines® in the next 180 days, and we'll give you $20.00 cash right now. If you agree, but do not take the trip, then no problem, we will charge your account for the $20.00, plus an additional processing fee of $4.00.

John's bank was participating as a third-party in presenting forward commitment agreements to its customers. Once John had inserted his ATM card into the ATM-type dispensing device 106, the bank's ATM (third party) server 118 notified a controller 102 of the present invention that John Smith was using an ATM. Upon receipt of this notice, the controller 102 accessed an online database to determine that John Smith uses an online personal information manager and that he has opted to make his future plans (detailed therein) available to the controller 102. Upon reviewing John's stored information, the controller 102 noticed that John was planning to travel to California to visit his aunt.

Previously, via a merchant device 112, United Airlines® had contacted the controller 102 and agreed to pay $35.00 for each customer with more than $5,000.00 in his bank account that the controller could get to commit to using United Airlines® for travel. The controller 102 sent the above offer to the bank's ATM (third party) server 118 and the bank's ATM (third party) server 118 decided to present the offer upon verifying that John Smith had an account balance greater than $5,000.00. Since John had planned on visiting his aunt out in California, he readily signaled his agreement to the above offer by pressing an “accept” button on the ATM's touch screen. The bank's ATM (third party) server 118 forwarded the indication of acceptance to the controller 102 and sent a signal to the ATM to dispense $20.00 to John.

Two months later, John flew to Colorado on United Airlines® to go on an unplanned skiing trip. The United Airlines® reservation and ticketing system sent a notice to the controller 102 that John Smith had fulfilled his commitment. The controller 102 updated its database to reflect the fulfilled status of John's forward commitment agreement.

### ADDITIONAL EMBODIMENTS OF THE INVENTION

The following are example alternative variations which illustrate additional embodiments of the present invention. It should be understood that the particular variations described in this section can be combined with the different embodiments, or portions thereof, described above in any manner that is practicable. These examples do not constitute a definition or itemization of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

The present invention may include the additional step of verifying that the consumer is legally able to enter into a forward commitment agreement. For example, a forward commitment agreement may be legally unenforceable if the consumer is under the age of 18. Thus, the controller 102 may, for example, consult a database of publicly available birth records. The dispensing device 106 may also scan or photograph an ID, such as a driver's license or passport belonging to the consumer. If the consumer possesses an item, such as a credit card, that is given out on an restrictive basis, then the controller 102 may infer the consumer's eligibility from the consumer's possession of the item.

In some embodiments, the dispensing device may use a built-in printer to print a generic or customized document describing the forward commitment. The consumer may enter into the forward commitment by signing the document. A camera built into the dispensing device 106, or proximate to the dispensing device may record the signing and thereby act as a witness. The consumer may insert the executed document, or a carbon copy of the executed document, into the dispensing device.

In some embodiments, a consumer device, such as a PDA, may enter into forward commitments on behalf of its owner or another person. The device may be preprogrammed to enter into forward commitments based on predefined parameters.

For example, a consumer may program his combination cell phone/PDA to accept any forward commitment agreement to dine at a local restaurant for $50 or less, in return for free phone minutes. Then, when the consumer walks by a phone card vending machine-type dispensing device 106, the vending machine may broadcast, via infrared frequencies, a forward commitment agreement to dine at Sam's Mexican Diner in the next week in return for 50 phone minutes. The cell phone/PDA may then accept the offer on the consumers behalf by beaming back the consumers identifying information. The cell phone/PDA may subsequently alert the consumer that he has entered into a forward commitment.

In some embodiments, the forward commitment may require the consumer to download processor instructions onto a consumer device. The computer instructions will cause the device to fulfill the forward commitment. In such embodiments, part or all of the responsibility of fulfilling the commitment is transferred to the consumer device.

For example, a forward commitment may require a cable box to receive instructions to tune to channel 45 on Sunday from 3:00 PM to 5:00 PM and at the same time block reception of any other channels. At the appointed time, the cable box may turn on the television, tune to channel 45, and play the relevant show. The consumer is relieved of having to remember when and what channel to watch, and merely needs to be present during the designated time period. In a similar example, a forward commitment may require a consumer to load software onto his personal computer (PC) that provides the controller with information gleaned from the PC.

In other embodiments, entering into a forward commitment may entail making a networked device available for the use of others. For example, a consumer may make his PC's computing cycles available for detecting extra-terrestrial signals when the PC is not otherwise in use. A related benefit may be to provide another consumer use of the first consumer's PC computing cycles.

In some embodiments, forward commitment agreements may include buyout or other termination provisions. Thus, a consumer who is unable to fulfill a forward commitment, may choose to: compensate the controller 102, find an alternate person to fulfill his forward commitment, and/or enter into a new forward commitment. In some embodiments, the controller 102 may agree to modify deadlines or other terms associated with the commitment simply because the consumer has shown good faith by notifying the controller 102 of his inability to fulfill the commitment.

The present invention may include the additional step of alerting a merchant that a consumer has entered into a forward commitment involving that merchant. For example, the consumer has agreed to dine at the merchants restaurant.

The present invention may also or alternatively include the additional step of the merchant reimbursing the controller 102 for any benefits provided to consumers via benefit dispensing devices 106. The controller 102 may keep track of money owed it by merchants in a database such as for example, a merchant database 212 as depicted in FIG. 7.

In some embodiments, consumers may receive ratings based on how often they fulfill forward commitments. The ratings may be used in determining what benefits and forward commitments to offer the consumer.

In some embodiments, forward commitments may include a commitment to make a purchase at a future time. The controller 102 may be granted the authority to make the purchase automatically on behalf of the consumer. In this embodiment, the consumer does not have to remember to make the purchase. For example, the consumer may provide a financial account number and his home address when agreeing to a forward commitment to purchase an, as yet, unavailable product. When the product becomes available, the controller 102 may charge the consumer's financial account automatically, and the product may be shipped directly to the consumer's home address.

In some embodiments of the present invention, a dispensing devices 106, particularly vending machine-type dispensing devices, may enter into forward commitment agreements with consumers without the use of or any connection to a central controller. In such an embodiment, a maintenance person may visit the dispensing device 106 on a periodic basis and retrieve a record of the forward commitment agreements consummated by the dispensing device 106. This record, which would include information similar to that stored in the forward commitment database 208 and the consumer database 210 described above, could be used to perform the steps of the present invention.

### CONCLUSION

It is clear from the foregoing discussion that the disclosed systems and methods to offer forward commitment agreements represents an improvement in the art of electronic commerce and automated sales. While the method and apparatus of the present invention has been described in terms of its presently preferred and alternate embodiments, those skilled in the art will recognize that the present invention may be practiced with modification and alteration within the spirit and scope of the appended claims. The specifications and drawings are, accordingly, to be regarded in an illustrative rather than a restrictive sense.

Further, even though only certain embodiments have been described in detail, those having ordinary skill in the art will certainly appreciate and understand that many modifications, changes, and enhancements are possible without departing from the teachings thereof. All such modifications are intended to be encompassed within the following claims.

1. A method of forming an agreement comprising:
identifying a consumer proximate to a benefit dispensing device;
receiving information about the consumer;
offering a benefit to the consumer in exchange for the consumer entering into a forward commitment agreement;
receiving the consumer's acceptance of the benefit and agreement to enter into the forward commitment agreement; and
providing the benefit to the consumer via the benefit dispensing device.

2-53. (canceled)
